(19) United States
(12) Patent Application Publication
(10) Pub. No.: US 2026/0051260 A1
(43) Pub. Date: Feb. 19, 2026

(54) AI-BASED METHOD FOR IDENTIFYING ERROR CAUSE, APPARATUS, DEVICE, AND STORAGE MEDIUM

(71) Applicant: Shanghai Squirrel Cloud Artificial Intelligence Technology Co., Ltd., Shanghai (CN)

(72) Inventors: Haoyang LI, Shanghai (CN); Tianlong XU, Bellevue, WA (US); Qingsong WEN, Bellevue, WA (US)

(73) Assignee: Shanghai Squirrel Cloud Artificial Intelligence Technology Co., Ltd., Shanghai (CN)

(21) Appl. No.: 19/010,525

(22) Filed: Jan. 6, 2025

(30) Foreign Application Priority Data
Aug. 16, 2024 (CN) 202411134042.4

(51) Int. Cl. G09B 7/04

(52) U.S. Cl. CPC G09B 7/04

(57) ABSTRACT

The present disclosure provides an AI-based method for identifying error cause, an apparatus, a device, and a storage medium. The method includes: responding to a user's upload operation of at least one draft paper file for at least one target question, where the draft paper file includes one or more problem-solving ideas or problem-solving steps generated by the user for the target question; acquiring at least one current user error cause generated by a trained error cause analysis model based on the at least one of the problem-solving idea or the problem-solving step; and determining an error cause analysis result of the draft paper file according to the current user error cause, and displaying the error cause analysis result on an answer page of the target question. Through the method, the accuracy of the identification of error cause can be improved.

### CROSS-REFERENCE TO RELATED APPLICATIONS

This application claims priority to Chinese Patent Application No. 202411134042.4, filed on Aug. 16, 2024, entitled “AI-Based Method for Identifying Error Cause, Apparatus, Device, and Storage Medium”, the entire disclosure of which is incorporated herein by reference for all purposes.

### TECHNICAL FIELD

The present disclosure relates to the technical field of intelligent education and artificial intelligence, in particular to an AI-based method for identifying error cause, an apparatus, a device, and a storage medium.

### BACKGROUND

With the development of artificial intelligence technology and its widespread application in the education field, various AI-based teaching products have emerged, such as products for step-by-step analysis of test question and products for exam paper marking. Moreover, the educational model is gradually shifting from the traditional teacher-centered approach to a student-centered one, thus the existing teaching systems urgently need to adapt to this change.

Generally, the teaching methods in the related art determine whether a student is encountering difficulty with a question by detecting the pause duration between the previous and current answer attempts, as well as the student's posture, and then provide problem-solving hints accordingly. However, these methods may not accurately distinguish whether the student has actually stopped answering or is merely thinking, leading to unnecessary interruptions and irrelevant prompts that may disrupt the student's thought process.

Of course, after a student answers a question, it is possible to simply determine the correctness based on the results of answer provided by the student. However, such right-or-wrong determination results may not explain in depth whether the cause of the student's error is a conceptual misunderstanding, a calculation mistake, or a complete lack of understanding of the relevant knowledge points. Additionally, given the individual differences in knowledge mastery and understanding among learners, existing intelligent learning machines often cannot provide customized guidance and suggestions based on learners' personalized needs, and lack interaction with learners regarding question-related aspects during the question-answering process, making it difficult to effectively stimulate learners' thinking.

Therefore, it is important to provide personalized learning approaches for learners.

### SUMMARY

The present disclosure provides an AI-based method for identifying error cause, an apparatus, a device, and a storage medium, to improve the accuracy of the identification of error cause.

According to a first aspect of the present disclosure, provided is an AI-based method for identifying error cause, the method including:
responding to a user's upload operation of at least one draft paper file for at least one target question, where the draft paper file includes one or more problem-solving ideas or problem-solving steps generated by the user for the target question;
acquiring at least one current user error cause generated by an error cause analysis model based on the at least one of the problem-solving idea or the problem-solving step; and
determining an error cause analysis result of the draft paper file according to the current user error cause, and displaying the error cause analysis result on an answer page of the target question.

According to a second aspect of the present disclosure, provided is an AI-based apparatus for identifying error cause, the apparatus including:
an operation response assembly, configured to respond to a user's upload operation of at least one draft paper file for at least one target question, where the draft paper file includes one or more problem-solving ideas or problem-solving steps generated by the user for the target question;
an error cause acquisition assembly, configured to acquire at least one current user error cause generated by an error cause analysis model based on the at least one of the problem-solving idea or the problem-solving step; and
a result generation assembly, configured to determine an error cause analysis result of the draft paper file according to the current user error cause, and display the error cause analysis result on an answer page of the target question.

According to a third aspect of the present disclosure, provided is an electronic device, including:
at least one processor; and
a memory communicatively connected with the at least one processor; where
the memory stores a computer program executable by the at least one processor, and the computer program are executed by the at least one processor to enable the at least one processor to perform the above-mentioned AI-based method for identifying error cause.

According to a fourth aspect of the present disclosure, provided is a non-transitory computer-readable storage medium, where the non-transitory computer-readable storage medium stores a computer instruction for causing a processor to perform the above-mentioned AI-based method for identifying error cause.

According to a fifth aspect of the present disclosure, provided is a computer program product, including:
a computer program, where the computer program is executable by a processor to perform the above-mentioned AI-based method for identifying error cause.

It should be understood that the technical solutions mentioned above are not intended to identify key or important features of the embodiments of the present disclosure, nor are they used to limit the scope of the present disclosure. Other features of the present disclosure will become easily understood through the following specification.

### BRIEF DESCRIPTION OF DRAWINGS

To more clearly illustrate the technical solutions in the embodiments of the present disclosure, a brief introduction to the drawings needed in the description of the embodiments is given below. Obviously, the drawings described below illustrate only parts of embodiments of the present disclosure. For those skilled in the art, other drawings may be obtained based on these drawings without creative labor.

FIG. 1 is a flow chart of an AI-based method for identifying error cause according to an embodiment of the present disclosure;

FIG. 2 is a schematic illustration showing a draft paper file according to an embodiment of the present disclosure;

FIG. 3 is a schematic illustration showing an application of an AI-based method for identifying error cause in mathematics according to an embodiment of the present disclosure;

FIG. 4 is a schematic illustration showing a draft paper file in mathematics according to an embodiment of the present disclosure;

FIG. 5 is a flow chart of a method for determining error cause analysis result according to an embodiment of the present disclosure;

FIG. 6 is a schematic illustration showing a draft paper file according to another embodiment of the present disclosure;

FIG. 7 is a flow chart of a method for determining error cause analysis result according to another embodiment of the present disclosure;

FIG. 8 is a schematic illustration showing an application of an AI-based method for identifying error cause in chemistry according to an embodiment of the present disclosure;

FIG. 9 is a schematic illustration showing a draft paper file in chemistry according to an embodiment of the present disclosure;

FIG. 10 is a schematic illustration showing an application of an AI-based method for identifying error cause in physics according to an embodiment of the present disclosure;

FIG. 11 is a schematic illustration showing a draft paper file in physics according to an embodiment of the present disclosure;

FIG. 12 is a schematic illustration showing an application of an AI-based method for identifying error cause in English according to an embodiment of the present disclosure;

FIG. 13 is a schematic illustration showing a draft paper file in English according to an embodiment of the present disclosure;

FIG. 14 is a structural illustration showing an AI-based apparatus for identifying error cause according to an embodiment of the present disclosure; and

FIG. 15 is a structural illustration showing an electronic device implementing an AI-based method for identifying error cause according to an embodiment of the present disclosure.

### DETAILED DESCRIPTION OF EMBODIMENTS

In order to facilitate a better understanding of the embodiments of the present disclosure by those skilled in the art, the technical solutions in the embodiments of the present disclosure will be clearly and completely described below in conjunction with the accompanying drawings in the embodiments of the present disclosure. Obviously, the described embodiments are only a part of the embodiments of the present disclosure and not all of the embodiments. Based on the embodiments in the present disclosure, all other embodiments obtained by a person of ordinary skill in the in art without creative labor shall fall within the scope of protection of the present disclosure.

It should be noted that the terms “first”, “second”, “third”, “fourth”, “candidate”, “target” and the like in the specification and claims of the present disclosure and the above-described drawings are used to distinguish similar objects and are not intended to describe a particular order or sequence. It should be understood that the data such used may be interchanged in an appropriate manner, so that the embodiments of the present disclosure described herein can be practiced in an order other than those illustrated or described herein. In addition, the terms “including”, “having”, and any variations thereof, are intended to cover non-exclusive embodiments, e.g., a process, method, system, product or apparatus including a series of steps or units need not be limited to those steps or units clearly listed, but may include other steps or units that are not clearly listed or that are inherent to the process, method, system, product or apparatus.

It should also be noted that the collection, storage, use, processing, transmission, provision, and disclosure of data related to draft paper files and other relevant data involved in the technical solutions of the present disclosure are handled in accordance with relevant laws and regulations and are not contrary to public order and morals.

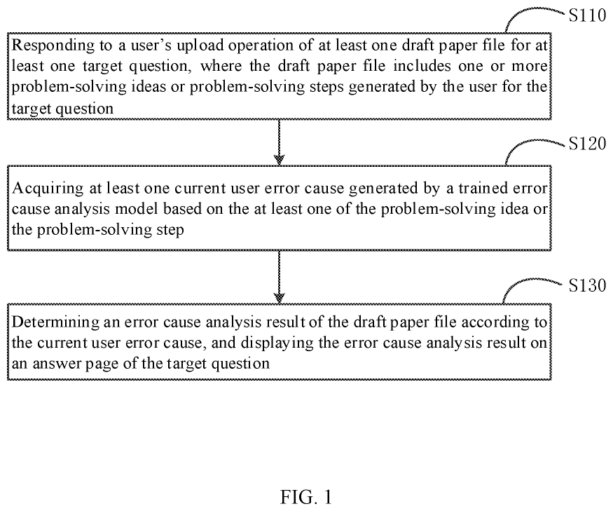

FIG. 1 is a flow chart of an AI-based method for identifying error cause according to an embodiment of the present disclosure. This embodiment may be applicable to a situation of identifying an error cause based on information of a learner's answer in a smart education scenario, and in particular to a situation of identifying an error cause based on information of a draft file of the answer, and the method may be performed by an AI-based apparatus for identifying an error cause, which may be implemented in the form of hardware and/or software, and may be integrated into an electronic device that hosts the AI-based function for identifying an error cause, such as a server. As shown in FIG. 1, the method includes:

S110, responding to a user's upload operation of at least one draft paper file for at least one target question, where the draft paper file includes one or more problem-solving ideas or problem-solving steps generated by the user for the target question.

The technical solutions of the present disclosure may be applied in scenarios where a student or a user formally makes an answer to a target question before, during, or after the answer is completed via a smart device, such as a learning machine.

The responding to a user's upload operation of at least one draft paper file for at least one target question may refer to receiving an uploaded draft paper file for a target question, and preforming optical character recognition or speech recognition on the draft paper file. The draft paper file may be in various forms, such as a draft image, a draft voice and the like, which are not limited in the present disclosure.

In accordance with one or more embodiments, a question-answering interface may include contents of multiple questions, or even different questions affiliated with different subjects. The target questions may involve various subjects, such as math, chemistry, physics, language, and so on.

In a case, if a user is in a mixed-answer scenario, e.g., a student is in a mode of answering questions in a mixture of multidisciplinary topics, before determining the target grade corresponding to the target question, it may be needed to determine whether the subject corresponding to the target question is mathematics, physics, or geography, in order to more accurately determine the grade corresponding to the question, so as to facilitate the identification of the error cause for the different grades.

Of course, by extension, the draft file uploaded by the student may also contain problem-solving steps or ideas generated for multiple questions.

The draft paper file includes one or more problem-solving ideas or problem-solving steps generated by the user for a question, such as a mathematics question. For example, it may be problem-solving ideas written on a draft paper for the mathematics question, or may be problem-solving steps written on the draft paper. Of course, it may also be a combination of the problem-solving ideas and the problem-solving steps.

The problem-solving ideas and the problem-solving steps in accordance with one or more embodiments may be illustrated with a chemistry question as an example.

Target Question: when 150 g of calcium carbonate is calcined at high temperature and cooled after a period of time, 22 g of carbon dioxide gas is measured to be generated. How much calcium oxide is in the remaining solid after the reaction? (Ca-40, C-12, O-16)

Problem-solving ideas in the draft paper file:

1. Calcium carbonate produces calcium oxide and carbon dioxide, where carbon dioxide escapes as gas.

2. Calcium oxide is 56 in relative molecular mass, carbon dioxide is 44 in relative molecular mass, where carbon dioxide is 22 g, calcium carbonate is 150 g.

3. The mass of calcium oxide may be found by making an equation.

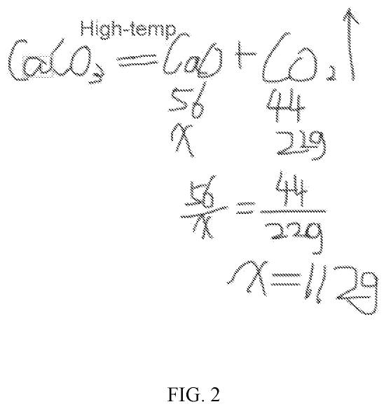

Alternatively, refer to the problem-solving steps shown in the draft paper file in FIG. 2. In this embodiment, the example of having only one question in the answer page and including only the draft file for that question is illustrated.

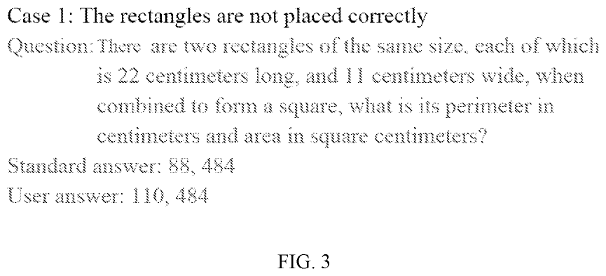

In this embodiment, the target question refers to the question that needs error cause identification, such as a mathematics question shown in FIG. 3. The draft paper file refers to a file containing all or part of the process of a student or user answering the target question, and specifically refers to a draft paper generated by a student or user during the problem-solving process for one or multiple questions; such draft paper may appear in various forms on different carriers, such as drawing boards, calculation papers, empty spaces, or even on palms; a student or user may upload handwritten draft paper content to a server or device through scanning, photographing, video recording, handwriting screen transcription, voice input, and other approaches.

In accordance with one or more embodiments, the draft paper file may also refer to content written by students using the draft paper function on the current answer page. When the student submits draft paper or completes answers, one or more pages of draft paper are automatically or manually selected to submit to the server for processing.

In another embodiment, the draft paper file may refer to a voice recording or video.

When a user, or specifically a student, cannot conveniently use pen and paper, he or she can click on the voice recording or video recording control buttons in the draft paper function to record his or her problem-solving ideas and steps through verbal explanation.

Through such way, the student is greatly facilitated to record his or her problem-solving ideas and it is easy for the student to use to review the problem-solving process.

In accordance with one or more embodiments, it is not limited to using the voice recording and video recording functions of the draft paper in the learning system to collect and upload draft paper files. Students can also use the voice recording and video recording functions built into their learning machines or mobile phones to collect draft paper files and upload them to the server through certain methods.

The beneficial effect of such technical solution is that: when students are not in the problem-solving process but suddenly think of a key solution while walking, they can first collect draft paper through this method, and then upload the draft paper file to verify their problem-solving ideas or answer the mathematics question. Through these diverse draft paper collection methods, students' problem-solving ideas may be recorded in a timely manner, thereby recording students' insights about questions for subsequent precise analysis of error causes.

In accordance with one or more embodiments, the S110 may include: responding to the user's answer operation for the target question, to take an electronic draft paper as the draft paper file when the electronic draft paper is detected; and responding to the user's upload operation of the electronic draft paper, and uploading the electronic draft paper to the server.

The answer operation refers to operations related to users starting to answer, such as users starting to write on the handwriting screen. The electronic draft paper refers to digital format drafts of one or more problem-solving ideas or problem-solving steps generated by users for the target question.

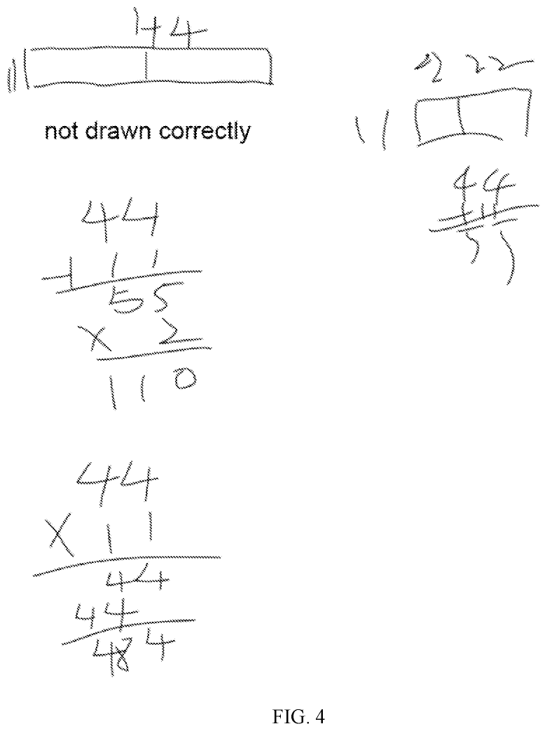

In accordance with one or more embodiments, as shown in FIG. 4, taking an intelligent learning machine with a handwriting display screen as an example, and using the case where users generate draft paper by writing in the draft paper area of a mathematics question answer page, the technical implementation of the present disclosure is described.

Additionally, by using electronic draft paper uploaded by students that contains problem-solving ideas and steps for the mathematics question, the problem of unclear image recognition caused by uploading paper drafts through photographs may be avoided; moreover, draft paper files containing answer steps include more student problem-solving information, thereby significantly improving the accuracy of subsequent error cause identification.

In this embodiment, draft images are used as a unique breakthrough point, making it possible to discover students' various error causes.

S120, acquiring at least one current user error cause generated by a trained error cause analysis model based on the at least one of the problem-solving idea or the problem-solving step.

In this embodiment, the error cause analysis model may be a large language model (LLM). The LLM firstly encodes the images and text in the received draft paper files separately, converting them into tokens that can be understood by the model, then performs mathematical matrix calculations, mainly using transformers and other implicit neural networks to reason and answer based on the input draft paper, deriving the logical chain of the problem-solving process, and summarizing and outputting error causes.

In accordance with one or more embodiments, the model locates student error causes by comparing draft paper content with model-generated standard answers or standard answers obtained from the exercise database.

In this embodiment, through comparing differences between draft paper and standard answers, error causes for problem-solving ideas or steps may be output based on user draft paper before formal answering, thereby providing timely feedback and personalized suggestions based on draft paper to enhance student learning motivation.

In accordance with one or more embodiments, to obtain more accurate error causes that account for over 90% of all error causes, such as non-knowledge point error causes due to carelessness, sloppiness, and unclear review of questions, users may also upload formal answer content. This solution may be used in scenarios where formal answer content has been submitted, and the input formal answer content is treated as part of the draft paper file.

In accordance with one or more embodiments, the LLM firstly compares formal answer content with standard answers, then combines the differences between steps in the student's draft paper and steps in the formal answer content analysis for reverse reasoning.

In accordance with one or more embodiments, when the answer content matches the standard answer, the draft paper is compared with the formal answer to identify problem-solving difference points, then the difference points' positions in the draft paper and answer content are located, to determine error causes based on contextual information of the difference positions. The difference position refers to the location of problem-solving difference points in draft paper and problem-solving steps of answer content, and the contextual information refers to the problem-solving step before and after the problem-solving steps corresponding to the difference positions.

It should be noted that the current user error cause refers to the reason why the user made an error based on the draft paper file uploaded by the user. When the draft paper file includes only the draft paper, whet is derived is the error cause in the draft paper. When the draft paper file includes the draft paper and also includes the formal answer content, in one case, there is no error in the problem-solving ideas or steps in the draft paper, but there is an error in the formal answer content uploaded by the user, the identified error cause is the user's error cause based on the formal answer derived from the draft paper.

The identified error cause may be specific to the location in the draft paper or formal answer content, for example, in a step of the plus or minus sign is written wrong, in the last step of the transcription is wrong, in a step of the formula is written wrong, etc.

In this embodiment, the LLM is used to conduct detailed analysis and logical reasoning of draft papers, thereby comprehensively determining user error causes through standard answers, answer analysis, and knowledge point definitions. By comparing students' actual written answers, students' possible incorrect steps may be reverse-deduced, achieving precise control and summarization of student error causes in different trigger scenarios based on different error cause contexts, thereby providing personalized guidance to students. Particularly for non-knowledge-related error causes like transcription errors, unclear review of questions, and carelessness, the recognition accuracy reaches 80%.

In an improved solution, even missing any one of formal answer content or draft paper, the LLM will still locate error causes through the students' formal answers or the draft paper.

Furthermore, to address the technical problem of various imperfect draft papers affecting error identification accuracy, such as draft papers containing incomplete information like omitted key steps, abbreviated final answers, or partially missing numbers, in this embodiment, the LLM may be used to focus on referencing student answers, complete student draft logic through analysis of incomplete drafts and student answers, restore partially missing draft information to locate error causes; then the error causes are obtained by comparing with the standard answer's logical chain.

To solve the technical problem of the LLM's weak ability in summarizing knowledge points and even weaker ability in summarizing knowledge points directly related to error causes, in an embodiment, the the LLM is also provided with artificial samples of different error cause distributions for reference in order to significantly improve its ability to summarize knowledge points related to error causes.

In this embodiment, an interaction record will also be written in the system as a strong reference to recommend the most needed knowledge points to the student.

In accordance with one or more embodiments, an example of model-generated error causes is as follows:

The error cause for the mathematics question in FIG. 3 is: the student did not understand that a square is required to form in the question, and instead calculated it as a rectangle, thus the area is correct but the perimeter is wrong.

Another example is: students at Red Star Elementary School took vision examinations; in the morning, 4 groups of students are examined, with 128 students per group; in the afternoon, 3 more groups were examined, with 234 students per group. How many more students were examined in the afternoon than in the morning?

Standard answer: 190.

User answer: 1214.

Current user error cause: when calculating the afternoon number, the student added the result of 234 multiplied by 3 (702 people) to the morning calculation result (512 people) instead of subtracting.

In accordance with one or more embodiments, before using the model to output error causes, the method includes: acquiring historical problem-solving information, where the historical problem-solving information includes a historical user error cause, a historical error cause type, and a historical error cause analysis result corresponding to one or more users' answer content for one or more target questions in one or more subjects; and inputting the historical user error cause, the historical error cause type, and the historical error cause analysis result into a large language model, training the large language model in a supervised manner until an output result of the large language model meets a preset result for the historical user error cause, the historical error cause type, and the historical error cause analysis result, and taking the trained large language model as the error cause analysis model.

In accordance with one or more embodiments, before conducting error cause identification through the model, or after the model's accuracy decreases, the specific technical solution for fine-tuning the model may be implemented through the following steps:
1) packaging questions, answers, explanations, knowledge point definitions, student answers, drafts, and other information together with expert-certified actual student error causes (including specific error causes and error cause types) into datasets;
2) collecting at least 100,000 datasets as described in step 1);
3) calling exclusive fine-tuning API of commercial large model (such as GPT4) to fine-tune the model (i.e., uploading data, and the backend API automatically adjusting the LLM's internal weights);
4) for open-source large models (such as Llama series, qianwen series, etc.), using the LLM's dedicated tokenizer to convert text data from step 1) into tokens-series matrices, further converting them into encoder, then inputting into a standard fine-tuning pipeline for fine-tuning (similarly, this process is a process of using new data to modify the LLM's existing weight matrices);
5) repackaging and encapsulating the fine-tuned model for calling.

In this embodiment, the large pre-trained model is trained using various exercise data, thereby improving the diversity and richness of training data, helping the model to more accurately understand and process exercise information, and enabling the model to perform better on different types and difficulties of exercises, generalizing to unseen questions. The model can learn effective problem-solving strategies and improve its ability to solve complex problems. More importantly, because the training data includes draft paper data from various students at different learning stages, grades, ages, subjects, and questions, it can accurately identify diverse error causes from different students, and provide targeted feedback to help students build knowledge systems based on the knowledge points and concepts contained in exercises.

Furthermore, in this embodiment, after error causes of learning and analysis thereof are generated through the model, learning paths may also be recommended based on students' learning progress and understanding level, to provide personalized learning resources based on students' own learning situations, thereby helping to reduce disparities in educational resource allocation.

S130, determining an error cause analysis result of the draft paper file according to the current user error cause, and displaying the error cause analysis result on an answer page of the target question.

In this embodiment, the error cause analysis result refers to the feedback content of the current user error cause, such as knowledge points, model-generated current user error causes, and the error cause types of these current user error causes.

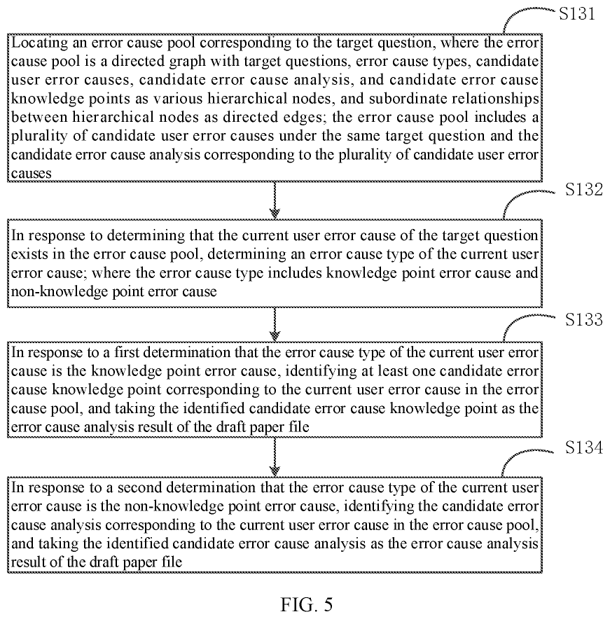

In accordance with one or more embodiments, as shown in FIG. 5, the determining an error cause analysis result of the draft paper file according to the current user error cause may be implemented through the following steps:

S131, locating an error cause pool corresponding to the target question, where the error cause pool is a directed graph with target questions, error cause types, candidate user error causes, candidate error cause analysis, and candidate error cause knowledge points as various hierarchical nodes, and subordinate relationships between hierarchical nodes as directed edges; the error cause pool includes a plurality of candidate user error causes under the same target question and the candidate error cause analysis corresponding to the plurality of candidate user error causes.

In accordance with one or more embodiments, all user error causes are cluster-classified to generate a sustainable iterative “error cause pool”, which summarizes error causes from different students for one exercise, including errors due to various reasons such as carelessness, unclear review of questions, weak knowledge points, and answer transcription errors. In this embodiment, three initial error causes are set for each exercise, and as time progresses and the project iterates, the error cause pool gradually becomes complete.

To improve computational efficiency and save resources, when locating student error causes, it is firstly considered whether similar candidate user error causes exist in the existing error cause pool. If so, the error cause analysis or error cause knowledge points corresponding to the candidate user error cause is output as the error cause analysis result. Then, when there are error causes for this exercise or similar error causes in the error cause pool, the current user error cause is not updated to the error cause pool; otherwise, it will be updated and added to the error cause pool.

In accordance with one or more embodiments, preset user error causes in the error cause pool have error cause types. In the error cause pool, the error causes are roughly categorized into major categories, and under major categories, error causes are further subdivided into minor categories; for each minor error cause category, detailed error descriptions/case descriptions are provided.

In accordance with one or more embodiments, major error cause categories may be summarized as knowledge point error causes and non-knowledge point error causes. Knowledge point error causes mean that the reason the user gets the exercise wrong is related to the knowledge points involved in the exercise, for example, the user misunderstands the knowledge or has not mastered the knowledge point. For a certain exercise, the knowledge point error may be: misunderstanding of “division”, error of multiplication of fractions, error of arrangement statistics, error of distributive law of multiplication, error of three-dimensional structure, and confusion of geometric properties, proportion relationship errors, and the like.

For example, a certain current user error cause belongs to the knowledge point error cause under major error cause categories in the error cause pool, and its corresponding minor category is circular area application error; proportion relationship error, with its corresponding description being: failing to correctly understand or apply proportion relationships.

Another example: the knowledge point error is confusion of geometric properties, with its corresponding description being: misusing circle diameter as radius.

Non-knowledge point error causes mean that the errors are unrelated to knowledge points, including user misunderstanding of questions, logical reasoning errors, habitual thinking errors, answer technique errors, handwriting transcription errors, attention and detail errors, calculation errors, and the like.

For example, a certain current user error cause belongs to the trap question under misunderstanding of questions (non-knowledge point error) in the error cause pool's major categories, with the error description or case description being: deliberately designed to test common misunderstandings or oversights, requiring careful analysis to avoid falling into the trap.

For another example, a user's major error cause category is handwriting transcription error under non-knowledge point error causes, with its minor category being “reversing numerator and denominator”, and its corresponding description being: student writing numerator and denominator positions incorrectly when writing fractions. The structure of the error cause pool may be in the following form:

Exercise 1 (certain math question)—candidate user error cause (student failing to understand that the question requires forming a square, but calculating it as a rectangle, so the area is correct but perimeter is wrong)—major error cause category (knowledge point error)—minor error cause category (geometric figure understanding error)—error description (regarding perimeter of rectangle and square, inaccurate determination of square).

Exercise 1 (certain math question)—candidate user error cause (writing area as perimeter, perimeter as area)—major error cause category (handwriting transcription error)—minor error cause category (thinking A but writing B)—error description (student thinking correctly but writing incorrectly).

### Another Example

Exercise 2 (certain chemistry question)—candidate user error cause (student calculating incorrectly when computing 56:X=44:22; correct result should be 28, but student's incorrect result is 112)—major error cause category (calculation error)—minor error cause category (pure calculation error)—error description (student making error during calculation process).

The candidate error cause analysis refers to the preset analysis of user error cause in the error cause pool, specifically referring to the textual description of why students got a certain exercise wrong. In an embodiment, the candidate error cause knowledge point refers to a preset knowledge point in the error cause pool related to the target question.

In accordance with one or more embodiments, when knowledge points are preset for user error causes with major category being knowledge point error causes, then the format of error cause pool may be:

Exercise 1 (certain math exercise)—candidate user error cause (student failing to understand that the question requires forming a square, but calculating it as a rectangle, so the area is correct but perimeter is wrong)—error cause knowledge points (error cause knowledge point 1, error cause knowledge point 2, error cause knowledge point 3)/—major error cause category (knowledge point error)—minor error cause category (geometric figure understanding error)—error description (regarding perimeter of rectangle and square, inaccurate square determination).

The error cause knowledge points and the major error cause categories may be at the same hierarchical node level.

In accordance with one or more embodiments, the error cause knowledge points and the major error cause categories may also be at different hierarchical node levels, depending on how the error cause pool is constructed, as long as attributes at the same hierarchical level are the same for easy retrieval, no specific limitations are made here.

For example, a classification details of an error cause pool are shown in Table 1.

TABLE 1
Classification Details of an Error Cause Pool

| Major error cause | Minor error cause | |
|---|---|---|
| category | category | Error description/example |
| Misunderstanding of | Ambiguous question | Unclear question statement or multiple |
| question | | possible interpretations, leading to |
| | | difficulties in understanding, requiring |
| | | accurate interpretation |
| Misunderstanding of | Missing key | Student overlooking key information in |
| question | information | the question statement |
| Logical reasoning error | Logical reasoning | Misunderstanding of promotional rules, |
| | mistake | such as “buy X get one free” |
| Habitual thinking error | Habitual thinking error | Fixed thinking patterns leading to |
| | | calculation errors, not considering |
| | | periodicity |
| Answer technique error | Correct answer, but | Student answering correctly but mark |
| | wrong mark on answer | incorrectly on the answer sheet |
| | sheet | |
| Answer technique error | Draft paper | Student calculating correctly on the draft |
| | transcription error | paper but making errors when transcribing |
| Answer technique error | Not following required | Student answering in the wrong order |
| | order | |
| Handwriting | Thinking A, but writing | Student thinking correctly but writing |
| transcription error | B | incorrectly |
| Handwriting | Reversed letter or word | Student writing letters or words in |
| transcription error | order | the wrong order |
| Handwriting | Extra or missing letters | Student omitting or adding extra letters |
| transcription error | | when writing |
| Handwriting | Correct calculation | Student calculating correctly but |
| transcription error | process, but wrong | transcribing numbers incorrectly |
| | number transcription | |
| Handwriting | Counting error | Student making mistakes when counting |
| transcription error | | |
| Attention and detail | Extra or missing zeros | Student making errors in handling zeros |
| error | | in numbers |
| Attention and detail | Decimal point | Student making errors in decimal point |
| error | placement error | placement |
| Attention and detail | No simplification | Student failing to simplify fractions |
| error | | appropriately |
| Attention and detail | Error of adding | Student making errors when using |
| error | parentheses | parentheses |
| Calculation error | Basic operation rule | Errors in addition, subtraction, |
| | error | multiplication, and division, such as |
| | | incorrect borrowing in subtraction or |
| | | decimal point errors |
| Calculation error | Calculation process | Improper handling of borrowing in |
| | error | subtraction, unit conversion errors |
| Calculation error | Skipping steps in | Student skipping necessary steps in the |
| | problem-solving | problem-solving process |
| Calculation error | Incorrect operation | Student failing to follow the correct |
| | order | order of operations, such as in mixed |
| | | operations with addition, subtraction, |
| | | multiplication, division, and parentheses |
| Knowledge point error | Mathematical concept | Unclear understanding of periodic |
| | misunderstanding | arrangements, improper application of |
| | | proportion relationships |
| Knowledge point error | Improper application | Incorrect problem-solving strategies, |
| | of mathematical models | such as finding the minimum value |
| Knowledge point error | Geometric area | Incomplete consideration when estimating |
| | misunderstanding | room area, not correctly subtracting excess |
| | | parts |
| Knowledge point error | Area formula | Incorrect application of area formulas, |
| | application error | such as erroneously adding side lengths |
| Knowledge point error | Confusion of geometric | Mistakenly using a circle's diameter |
| | properties | in place of its radius |
| Knowledge point error | Proportion relationship | Incorrect understanding or application of |
| | error | proportion relationships |
| Knowledge point error | Remainder error | Incorrectly handling or understanding the |
| | | concept of remainders in division processes |

S132, in response to determining that the current user error cause of the target question exists in the error cause pool, determining an error cause type of the current user error cause; where the error cause type includes knowledge point error cause and non-knowledge point error cause.

The knowledge point error cause refers to an error caused by students' insufficient mastery or misunderstanding of specific knowledge points or concepts. Non-knowledge point error cause refers to an error not caused by insufficient knowledge point mastery but by other factors, which may belong to minor categories including unclear review of questions, carelessness, and transcription errors.

In this embodiment, a scenario is used as an example to illustrate the model's implementation of error cause classification:

The implementation logic is to find the k most similar types in the error cause categories based on similarity using the LLM's output specific error causes, then through the LLM's one-by-one comparison to determine the final error cause type (both major and minor error cause categories may be implemented this way), where the determination order is that the major category is firstly determined (defining the scope of minor categories), then the minor category is determined.

For example:

### Scenario 1:

Knowledge point name: three-digit number multiplied by two-digit number—multiplication and addition, multiplication and subtraction word problem.

Question text: workshop one produces 108 parts per day, which is 19 parts fewer than workshop two produces per day. How many parts can workshop two produce in 29 days?

Answer: (108+19)×29=127×29=3683 (parts). Answering: workshop two can produce 3683 parts in 29 days. Therefore, the answer is: 3683.

Specific error cause: the student made a calculation error when computing 127×29, intending to use the shortcut method of 127×30−127, but in the final step incorrectly copied the minuend as 127 instead of 29.

Error-related LLM knowledge points or suggestions: [knowledge points students need to learn additionally] simplified calculation of two-digit multiplication. When one of the numbers being multiplied is close to a multiple of ten, multiplication can be converted to a combination of multiplication and addition/subtraction operations, namely first calculating the multiplication with the multiple of ten, then subtracting the excess or adding the missing parts.

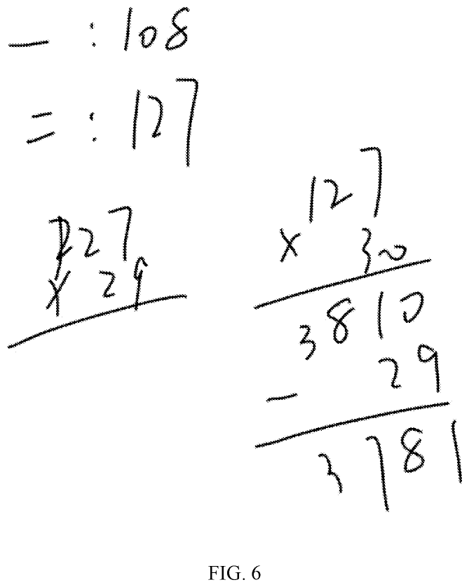

Student draft: As shown in FIG. 6.

Knowledge point name 1: three-digit number multiplied by two-digit number—multiplication and addition, multiplication and subtraction word problems.

Knowledge point definition: word problem: I. given a quantity A, divided into B portions, each portion being C, find how much remains; II. second, the formulated equation involves multiplication with addition or subtraction in two steps, where the multiplication part involves a three-digit number times a two-digit number, the equation may or may not have parentheses.

Major error cause category: knowledge point error.

Major error cause category definition: errors caused by insufficient understanding of the knowledge points of the current question.

Minor error cause category: knowledge point error. Minor error cause category definition: core knowledge points not mastered.

S133, in response to a first determination that the error cause type of the current user error cause is the knowledge point error cause, identifying at least one candidate error cause knowledge point corresponding to the current user error cause in the error cause pool, and taking the identified candidate error cause knowledge point as the error cause analysis result of the draft paper file.

S134, in response to a second determination that the error cause type of the current user error cause is the non-knowledge point error cause, identifying the candidate error cause analysis corresponding to the current user error cause in the error cause pool, and taking the identified candidate error cause analysis as the error cause analysis result of the draft paper file.

In accordance with one or more embodiments, after determining the error cause analysis result of the draft paper file, the current user error cause generated by the error cause analysis model, the error cause analysis result, and the first error cause knowledge point are updated to the error cause pool.

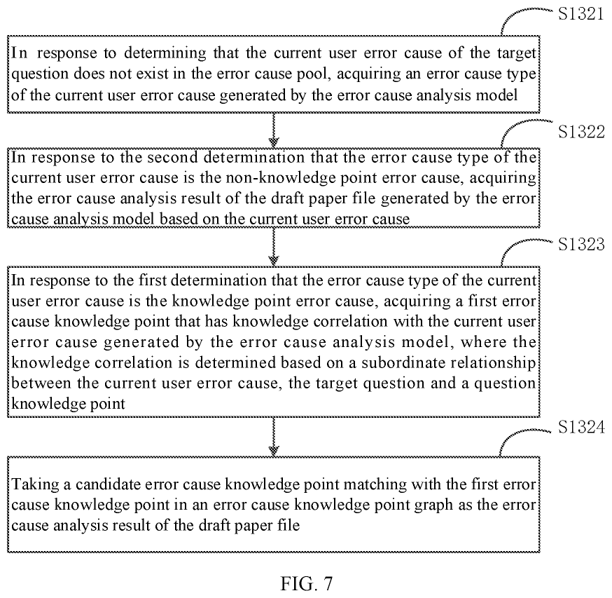

In accordance with one or more embodiments, as shown in FIG. 7, when the current user error cause for the target question does not exist in the error cause pool, the error cause analysis result may be determined through the following steps:

S1321, in response to determining that the current user error cause of the target question does not exist in the error cause pool, acquiring an error cause type of the current user error cause generated by the error cause analysis model.

The implementation for identifying the error cause types of the current user error cause by the error cause analysis model may be:

Acquiring a first error cause knowledge point that has knowledge correlation with the current user error cause generated by the error cause analysis model, and taking the first error cause knowledge point that has the highest correlation with the current user error cause as the core error cause knowledge point; and identifying from the draft paper file whether draft content related to the core error cause knowledge point exist.

Determining the error cause type of the current user error cause as the knowledge point error cause when no draft content related to the core error cause knowledge point exists in the draft paper file.

Determining the error cause type of the current user error cause as the non-knowledge point error cause when draft content related to the core error cause knowledge point exists in the draft paper file.

In this embodiment, the core error cause knowledge point refers to the error cause knowledge point with the highest degree of correlation with the current user error cause.

It can be understood that, by comparing the error cause knowledge points with draft content in the draft paper file to determine the error types of corresponding error causes, the accuracy of error cause identification is improved, thereby making the identified error cause types more aligned with users, and enhancing user experience.

Moreover, as a exemplified implementation, the identification of error cause types is performed only for error causes that do not exist in the error cause pool so that the burden of model is greatly reduced and the output efficiency is improved.

In accordance with one or more embodiments, after acquiring the identified error types, the following steps are further performed:

S1322, in response to the second determination that the error cause type of the current user error cause is the non-knowledge point error cause, acquiring the error cause analysis result of the draft paper file generated by the error cause analysis model based on the current user error cause.

The error cause analysis result in this step may be direct error analysis of the current user error cause.

S1323, in response to the first determination that the error cause type of the current user error cause is the knowledge point error cause, acquiring a first error cause knowledge point that has knowledge correlation with the current user error cause generated by the error cause analysis model, where the knowledge correlation is determined based on a subordinate relationship between the current user error cause, the target question and a question knowledge point.

For example, Exercise 1: there are two rectangles of the same size, each of which is 22 centimeters long, and 11 centimeters wide, when combined to form a square, what is its perimeter in centimeters and area in square centimeters?

The current user error cause is: the student did not understand that the question required forming a square, and instead calculated it as a rectangle, so the area is correct but the perimeter is wrong.

Knowledge points that have knowledge correlation with the current user error cause may include:
(1) application of area formulas of rectangle and square;
(2) characteristics of rectangle and square;
(3) properties of squares;
(4) perimeter of rectangle and square;
(5) determination of square;
(6) calculation formulas for areas of rectangle and square;
(7) given a rectangle's perimeter and length (or width), find width (or length);
. . .

All the above knowledge points belong to those involved in Exercise 1, and based on the current user error cause, the first knowledge point error cause that has correlation with these knowledge points may be:
(1) application of area formulas of rectangle and square;
(4) perimeter of rectangle and square;
(5) determination of square;
(7) given a rectangle's perimeter and length (or width), find width (or length).

Besides outputting and displaying the first error cause knowledge point on the answer page, all involved knowledge points may be displayed on the answer page for students' reference and learning.

The knowledge correlation is used to describe the degree of correlation between the error cause knowledge points and the current user error cause, and the subordinate relationship is preset through numerous experiments or empirical values, and used to describe the relationship between the current user error cause, the target question and the question knowledge point.

S1324, taking a candidate error cause knowledge point matching with the first error cause knowledge point in an error cause knowledge point graph as the error cause analysis result of the draft paper file.

The error cause knowledge point graph is a graph including various knowledge points, with main logical relationships including the sequence of knowledge points, grade attributes of knowledge points, prerequisite and subsequent relationships between knowledge points, and the like.

In accordance with one or more embodiments, the technical implementation for acquiring similar error cause knowledge points from the error cause knowledge point graph may be:

Matching similarity with the error cause knowledge point graph based on a matrix in the implicit data space of “embedding”, where “embedding modeling” is a specialized term in machine learning. text or image information is converted into tokens that computers can understand, then through mathematical matrix transformation, the token sequence is converted into a dense matrix. Finally, the representation of a sentence or image's semantics or meaning is achieved using a matrix.

In accordance with one or more embodiments, the semantic mathematical matrices of error cause knowledge points output by various models and the semantic matrices of knowledge points in the error cause knowledge point graph are calculated, then the most similar set between them is retrieved, and the knowledge points in this set are taken as the error cause analysis result output to students.

In accordance with one or more embodiments, when screening similar knowledge points, one-to-one discrimination is needed for the knowledge points, that is, one-to-one discrimination of the correlation degree between error-related knowledge points and the knowledge points in the error cause knowledge point graph.

After the error cause knowledge points are screened, they still belong to general natural language knowledge points. In this embodiment, these error cause knowledge points need to be aligned with preset knowledge points of nano subjects.

In accordance with one or more embodiments, the Retrieval Augmented Generation framework (RAG) may be used to perform necessary steps such as coarse screening, fine screening, and large model re-screening scoring of related knowledge points.

In this embodiment, the LLM generates some first error cause knowledge points summarized based on the current user error causes, which may be 1, 2, or more in quantity; then the Retrieval-Augmented Generation (RAG) is used to retrieve similar knowledge points from all knowledge points in the error cause knowledge point graph, achieving precise matching between error cause knowledge points and curriculum-related knowledge points, and enabling precise positioning of error cause knowledge points with an accuracy rate of 80%.

An exemplified method is to define the retrieval scope of the knowledge point graph beforehand. For example, before retrieval, the subject and grade corresponding to the exercise are first determined, then knowledge point retrieval under the corresponding subject and grade is performed, to reduce model computation load and improve computation speed.

The LLM may also be used to perform one-to-one discrimination between screened knowledge points and user error causes, selecting truly qualified knowledge points as error cause knowledge points. In an embodiment, the top five ranked knowledge points are selected as the screened error cause knowledge points.

In accordance with one or more embodiments, in the LLM's discrimination of knowledge points and error causes, a scoring and reordering method is adopted, having the LLM output a confidence score for correlation (for example, when the score range is 1 to 10, then 1 represents least correlated, 10 represents most correlated, and so on), rather than simply determining correlated or uncorrelated. In this way, additional information obtained by the LLM may be used as a basis for fine-grained ranking.

In accordance with one or more embodiments, hybrid embedding models may also be introduced to improve the accuracy of knowledge point screening.

The “embedding model” is a very important and widely applied dense matrix retrieval model in the retrieval field. “Keyword model” mainly relies on the similarity of statistical distribution between keywords and terms in retrieval fields and those in the text library to retrieve useful information. The combination of the two is called a “hybrid embedding model”.

For example, weights may be designed with 50% keyword retrieval weight and 50% dense matrix retrieval weight. The hybrid embedding model will then comprehensively consider both outputs, finally returning a weighted (1:1) result list from both result lists. When the weights are set to 30% and 70%, it's equivalent to selecting 30% of keyword retrieval results plus 70% of dense matrix retrieval results. When weights are set to 0% and 100%, it's equivalent to only using dense matrix for retrieval, and vice versa.

In this embodiment, the hybrid embedding model is applied to the RAG system, playing a crucial role in building connections between exercise analysis and knowledge point definitions, making great contributions to “providing high-quality data to the LLM”, especially significantly improving the efficiency of finding mathematics exercise knowledge points, such as extension of retrieval keyword, with about 30% higher retrieval accuracy compared to traditional RAG.

In this step, the candidate error cause knowledge points refer to error cause knowledge points preset in the error cause knowledge point graph. The error cause knowledge point graph is preset through numerous experiments or empirical values, storing the structural mapping of relationships between target questions, error types, candidate user error causes, candidate error cause analysis, and candidate error cause knowledge points. It should be noted that the number of candidate error cause knowledge points stored in the error cause knowledge point graph is greater than those stored in the error cause pool.

In accordance with one or more embodiments, to more accurately obtain knowledge points that users might need to learn and precisely target students' weak knowledge points, after obtaining knowledge points similar to the first error cause knowledge points from the error cause knowledge point graph and taking them as the second error cause knowledge points, historical answer data of the target problem may be obtained, where historical answer data includes the first knowledge point set learned by students who correctly answered the target question, and the second knowledge point set learned by students who incorrectly answered the target question; at least one candidate error cause knowledge point that exists in the first knowledge point set but not in the second knowledge point set is taken as the third error cause knowledge point; the second error cause knowledge points and the third error knowledge points are taken as the error cause analysis result of the draft paper file.

For example, for question P1, student S1 answered it correctly, while student S2 answered it incorrectly. Student S1 has learned knowledge points A, B, C, and D, while student S2 has learned knowledge points B, and D. Then student S2 likely needs knowledge points A, and C. The knowledge points A, and C may be considered as a local part of the entire error cause knowledge point graph. Suppose the complete knowledge point graph library is ABCDEFG . . . XYZ. Student 1 has learned ABCD, student 2 has learned BD, then the missing AC are likely what student 2 needs. Searching within this scope is more efficient than having to search through the entire ABCDEFG . . . XYZ. The search method mainly uses defined semantic similarity between error cause knowledge points generated by the large model and actual error cause knowledge point (top N), followed by large model confirmation (top K).

It should be noted that in accordance with one or more embodiments, the construction of the error cause knowledge point graph follows the same thought process as the above graphs.

In this implementation, key information such as knowledge point graphs and student learning history are interpreted, using the differences between “knowledge points learned by students who correctly answered” and “knowledge points learned by students who incorrectly answered” to create a candidate pool of error-cause-related knowledge points, focusing on knowledge points needed for correct problem-solving. This enables more targeted learning and improves student learning efficiency. Additionally, excluding knowledge points that led students to answer questions incorrectly concentrates learning resources and time on effective knowledge points, avoiding wasting time on unimportant or incorrect concepts, helping to avoid repeating others' mistakes.

In accordance with one or more embodiments, knowledge points that the student has already learned and mastered to a preset level may be removed from these knowledge points. The preset level may be determined based on the student's historical problem-solving information. For example, if there are 100 exercises corresponding to that knowledge point and the student's accuracy rate is 90%, it can be determined that the student's mastery of that knowledge point has reached the preset level.

This method allows customization of learning plans based on individual learning situations, achieving personalized learning and quickly identifying and correcting one's knowledge blind spots or misconceptions.

In another embodiment, the answer page includes an answer area. Correspondingly, after determining the error cause analysis result of the draft paper file according to the current user error cause and displaying the error cause analysis result on the answer page of the target question, the second and third error cause knowledge points may be displayed in the bottom area of the answer area. In response to a user's click operation on any error cause knowledge point among the second or third error cause knowledge points in the bottom area, the knowledge analysis content corresponding to the clicked error cause knowledge point is displayed on the answer page, where the knowledge analysis content includes one or more types of video content or graphic content.

In this embodiment, the answer area refers to the area for users to answer the target question. The knowledge analysis content refers to content that analyzes error cause knowledge points to facilitate user understanding; it may be knowledge point explanation videos, knowledge point diagrams, etc.

Based on the above embodiments, after determining the current user error cause, associated questions related to at least one candidate error cause knowledge point, first error cause knowledge point, second error cause knowledge point, and third error cause knowledge point corresponding to the current user error cause may be respectively determined; and these associated questions may be pushed. To facilitate a better understanding, based on the above embodiments, some specific examples are described as follows:

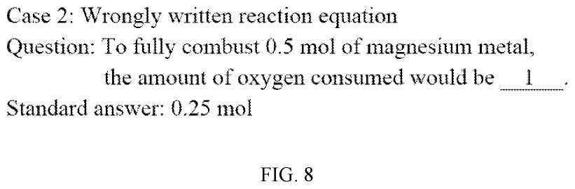

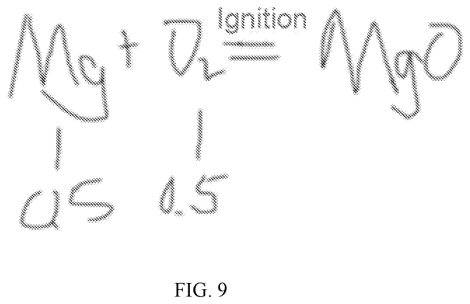

For example, the target question involves chemistry subject, as shown in FIGS. 8 and 9; in response to the problem-solving steps in the draft paper shown in FIG. 9 uploaded by the user for the chemistry problem shown in FIG. 8; the error cause analysis model generates the current user error cause based on the problem-solving steps in FIG. 9 as: the reaction equation for magnesium and oxygen is written as 2Mg+O2=2MgO, and the reaction equation is written incorrectly. Since knowledge points related to reaction equations appear in the draft paper, this user error cause may be classified as a knowledge point error cause; if this user error cause is identified in the error cause pool, then the candidate error cause knowledge points corresponding to the current user error cause identified in the error cause pool may be selected as the error cause analysis result for the draft paper file, such as: methods for balancing chemical equations, balancing chemical equations and related calculations, magnesium and aluminum oxides.

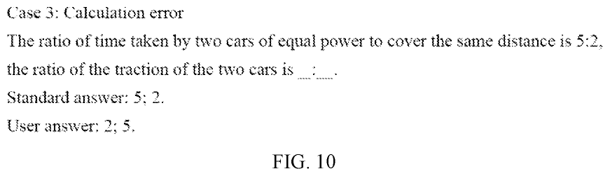

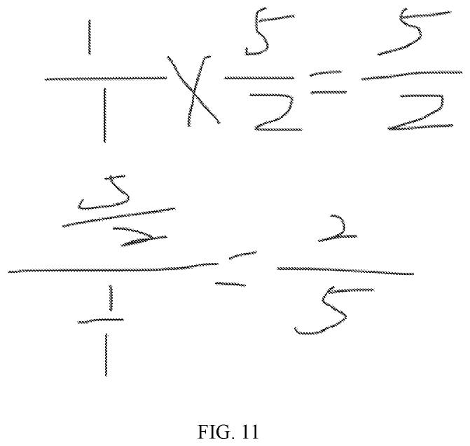

For another example, the target question involves physics subject, as shown in FIGS. 10 and 11; the user inputs draft paper shown in FIG. 11 for the target question shown in FIG. 10; the model analyzes it and obtains a current user error cause as: when the student simplified the calculation 5/2:1/1, he or she calculated incorrectly, 5 should remain in the numerator and 2 in the denominator, but they were actually written reversed, the error cause type is calculation error under non-knowledge point errors; the candidate error cause analysis corresponding to the current user error cause may be identified in the error cause pool as the error cause analysis result of the draft paper file, such as: the steps of solving this question are correct from the beginning until just before the last step, unfortunately when calculating the final result, 2/5 was calculated as 5/2, such basic error leading to lost points must be eliminated in the future.

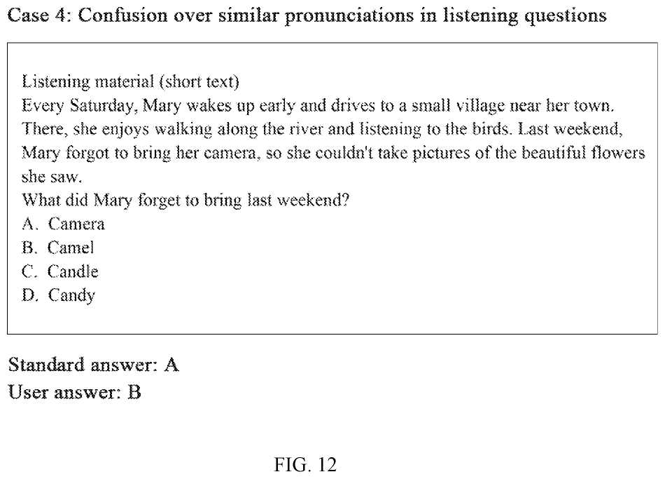

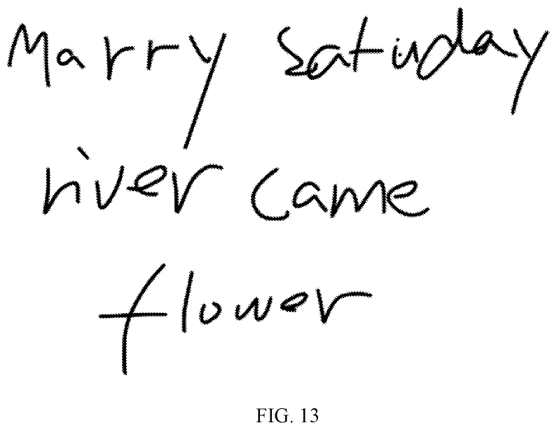

For example, the target question involves English subject, FIG. 12 shows a screen image of an English question in the test page of a learning machine, and FIG. 13 shows the corresponding solution steps; based on the solution steps in FIG. 13, the model outputs the current user error: when taking dictation notes, the student didn't record the word “camera” completely, or didn't know how to spell the word “camera”, leading to choosing the similarly pronounced word “camel”; the error cause type of the current user error cause is determined as knowledge point error cause; at least one candidate error cause knowledge point corresponding to the current user error cause in the error cause pool is identified as the error cause analysis result of the draft paper file, such as: phonetics-target phoneme / [symbol] /, phonetics-target phoneme / [symbol] /, phonetics-target phoneme /m/.

In the embodiments of the present disclosure, provided is an AI-based method for identifying error cause, the method including: responding to a user's upload operation of at least one draft paper file for at least one target question, where the draft paper file includes one or more problem-solving ideas or problem-solving steps generated by the user for the target question; acquiring at least one current user error cause generated by an error cause analysis model based on the at least one of the problem-solving idea or the problem-solving step; and determining an error cause analysis result of the draft paper file according to the current user error cause, and displaying the error cause analysis result on an answer page of the target question. Through the above technical solutions, by using a large model to analyze the error cause in the answer file, error causes can be accurately located, thereby determining the error cause analysis result of the user's error cause, improving the accuracy of identifying error cause knowledge points, and thus providing personalized guidance to learners.

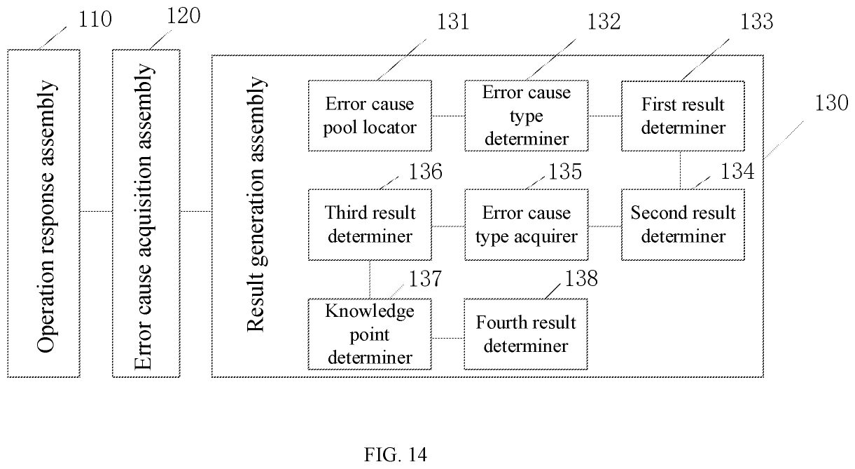

FIG. 14 is a structural illustration showing an AI-based apparatus for identifying error cause according to an embodiment of the present disclosure. This embodiment is applicable to scenarios of identifying error causes based on learners' answer information in intelligent education settings, especially for identifying error causes based on draft file information from answers. This apparatus may be implemented in hardware and/or software form and may be integrated into electronic devices carrying artificial intelligence-based error cause identification functions, such as servers. As shown in FIG. 14, the apparatus includes:
an operation response assembly 110, configured to respond to a user's upload operation of at least one draft paper file for at least one target question, where the draft paper file includes one or more problem-solving ideas or problem-solving steps generated by the user for the target question;
an error cause acquisition assembly 120, configured to acquire at least one current user error cause generated by a trained error cause analysis model based on the at least one of the problem-solving idea or the problem-solving step; and
a result generation assembly 130, configured to determine an error cause analysis result of the draft paper file according to the current user error cause, and display the error cause analysis result on an answer page of the target question.

In the embodiments of the present disclosure, the corresponding method includes: responding to a user's upload operation of at least one draft paper file for at least one target question, where the draft paper file includes one or more problem-solving ideas or problem-solving steps generated by the user for the target question; acquiring at least one current user error cause generated by a trained error cause analysis model based on the at least one of the problem-solving idea or the problem-solving step; and determining an error cause analysis result of the draft paper file according to the current user error cause, and displaying the error cause analysis result on an answer page of the target question. Through the above technical solutions, by using a large model to analyze the error cause in the answer file, error causes can be accurately located, thereby determining the error cause analysis result of the user's error cause, improving the accuracy of identifying error cause knowledge points, and thus providing personalized guidance to learners.

In accordance with one or more embodiments, the result generation assembly 130 includes:
an error cause pool locator 131, configured to locate an error cause pool corresponding to the target question, where the error cause pool is a directed graph with target questions, error cause types, candidate user error causes, candidate error cause analysis, and candidate error cause knowledge points as various hierarchical nodes, and subordinate relationships between hierarchical nodes as directed edges; the error cause pool includes a plurality of candidate user error causes under the same target question and the candidate error cause analysis corresponding to the plurality of candidate user error causes;
an error cause type determiner 132, configured to, when the current user error cause of the target question exists in the error cause pool, determine an error cause type of the current user error cause; where the error cause type includes knowledge point error cause and non-knowledge point error cause;
a first result determiner 133, configured to, when the error cause type of the current user error cause is the knowledge point error cause, identify at least one candidate error cause knowledge point corresponding to the current user error cause in the error cause pool, and take the identified candidate error cause knowledge point as the error cause analysis result of the draft paper file; and
a second result determiner 134, configured to, when the error cause type of the current user error cause is the non-knowledge point error cause, identify the candidate error cause analysis corresponding to the current user error cause in the error cause pool, and take the identified candidate error cause analysis as the error cause analysis result of the draft paper file.

In accordance with one or more embodiments, the result generation assembly 130 further includes:
an error cause type acquirer 135, configured to, when the current user error cause of the target question does not exist in the error cause pool, acquire an error cause type of the current user error cause generated by the error cause analysis model;
a third result determiner 136, configured to, when the error cause type of the current user error cause is the non-knowledge point error cause, acquire the error cause analysis result of the draft paper file generated by the error cause analysis model based on the current user error cause;
a knowledge point determiner 137, configured to, when the error cause type of the current user error cause is the knowledge point error cause, acquire a first error cause knowledge point that has knowledge correlation with the current user error cause generated by the error cause analysis model, where the knowledge correlation is determined based on a subordinate relationship between the current user error cause, the target question and a question knowledge point; and
a fourth result determiner 138, configured to take a candidate error cause knowledge point matching with the first error cause knowledge point in an error cause knowledge point graph as the error cause analysis result of the draft paper file.

In accordance with one or more embodiments, the knowledge point determiner 137 is further configured to:
acquire a candidate error cause knowledge point matching with the first error cause knowledge point from the error cause knowledge point graph as a second error cause knowledge point;
acquire historical answer data of the target question, where the historical answer data includes a first knowledge point set learned by learners who correctly answered the target question, and a second knowledge point set learned by learners who incorrectly answered the target question;
take at least one candidate error cause knowledge point that exists in the first knowledge point set but not in the second knowledge point set as a third error cause knowledge point; and
take the second error cause knowledge point and the third error cause knowledge point as the error cause analysis result of the draft paper file.

In accordance with one or more embodiments, the third result determiner 136 is further configured to:
after acquiring the first error cause knowledge point that has knowledge correlation with the current user error cause based on the current user error cause generated by the error cause analysis model, take the first error cause knowledge point that has the highest correlation with the current user error cause as the core error cause knowledge point; and
determine the error cause type of the current user error cause as the knowledge point error cause when draft content related to the core error cause knowledge point does not exist in the draft paper file.

In accordance with one or more embodiments, the operation response assembly 110 is further configured to:
respond to the user's answer operation for the target question, to take an electronic draft paper as the draft paper file when the electronic draft paper is detected; and
respond to the user's upload operation of the electronic draft paper.

In accordance with one or more embodiments, the answer page includes an answer area; correspondingly, the result generation assembly 130 is further configured to:
after displaying the error cause analysis result on an answer page of the target question, display the second error cause knowledge point and the third error cause knowledge point on a bottom area of the answer area; and
in response to a user's click operation on any error cause knowledge point among the second error cause knowledge point or the third error cause knowledge point in the bottom area, display knowledge analysis content corresponding to the clicked error cause knowledge point on the answer page, where the knowledge analysis content comprises one or more of video content or graphic content.

In accordance with one or more embodiments, the result generation assembly 130 is further configured to:
update the current user error cause, the error cause analysis result, and the first error cause knowledge point generated by the error cause analysis model into the error cause pool.

In accordance with one or more embodiments, the operation response assembly 110 is further configured to:
before responding to a user's upload operation of at least one draft paper file for at least one target question, acquire one or more of a standard answer of the target question or a user's answer content for the target question, and update the draft paper file by taking the one or more of the standard answer of the target question or the user's answer content for the target question as part of the draft paper file.

In accordance with one or more embodiments, the error cause acquisition assembly 120 is further configured to:
when the error analysis model identifies that the user's problem-solving process for the target question in the draft is incorrect, locate the solution difference points between the problem-solving process in the draft and formal answer steps; and
locate the difference position of problem-solving difference points in the draft paper file, to instruct the error cause analysis model to generate contextual information based on the difference position, and determine at least one current user error cause.

In accordance with one or more embodiments, the error cause analysis model may be determined through the following methods:
acquiring historical problem-solving information, where the historical problem-solving information includes a historical user error cause, a historical error cause type, and a historical error cause analysis result corresponding to one or more users' answer content for one or more target questions in one or more subjects; and
inputting the historical user error cause, the historical error cause type, and the historical error cause analysis result into a large language model, training the large language model in a supervised manner until an output result of the large language model meets a preset result for the historical user error cause, the historical error cause type, and the historical error cause analysis result, and taking the trained large language model as the error cause analysis model.

In accordance with one or more embodiments, the result generation assembly 130 is further configured to:
determine associated questions respectively related to the at least one candidate error cause knowledge point, the first error cause knowledge point, the second error cause knowledge point and the third error cause knowledge point corresponding to the current user error cause; and
push the associated questions.

The AI-based apparatus for identifying error cause provided by the present disclosure can execute any AI-based method for identifying error cause provided, having corresponding functional modules and beneficial effects for executing the method.

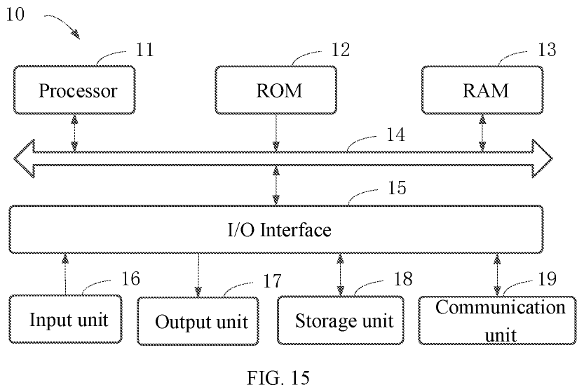

FIG. 15 is a structural illustration showing an electronic device implementing an AI-based method for identifying error cause according to an embodiment of the present disclosure. FIG. 15 shows the structural diagram of electronic device 10 that can be used to implement the embodiments of the present disclosure. The electronic device is intended to represent various forms of digital computers, such as laptops, desktop computers, workstations, personal digital assistants, servers, blade servers, mainframes, and other suitable computers. The electronic device may also represent various forms of mobile devices, such as personal digital processors, cellular phones, smartphones, wearable devices (such as helmets, glasses, watches, etc.) and other similar computing devices. The components shown here, their connections and relationships, and their functions are meant only as examples and are not intended to limit the technical solutions described and/or claimed.

As shown in FIG. 15, the electronic device 10 includes at least one processor 11, and memory communicatively connected with the at least one processor 11, such as read-only memory (ROM) 12, random access memory (RAM) 13, etc., where the memory stores computer programs that can be executed by the at least one processor. The processor 11 can perform various appropriate acts and processing according to computer programs stored in read-only memory (ROM) 12 or loaded from storage unit 18 to random access memory (RAM) 13. In the RAM 13, various programs and data needed for operating the electronic device 10 can also be stored. The processor 11, ROM 12, and RAM 13 are connected to each other through a bus 14. Input/output (I/O) interface 15 is also connected to the bus 14.

Multiple components in the electronic device 10 are connected to the I/O interface 15, including: input unit 16, such as keyboard, mouse, etc.; output unit 17, such as various types of displays, speakers, etc.; storage unit 18, such as magnetic disks, compact disks, etc.; and communication unit 19, such as network cards, modems, wireless communication transceivers, etc. The communication unit 19 allows the electronic device 10 to exchange information/data with other devices through computer networks such as the Internet and/or various telecommunications networks.

The processor 11 can be various general and/or special-purpose processing components with processing and computing capabilities. Some examples of processor 11 include but are not limited to central processing units (CPU), graphics processing units (GPU), various specialized artificial intelligence (AI) computing chips, various processors running machine learning model algorithms, digital signal processors (DSP), and any appropriate processors, controllers, microcontrollers, etc. The processor 11 performs the various methods and processes described above, such as the AI-based method for identifying error cause.

In accordance with one or more embodiments, the AI-based method for identifying error cause can be implemented as computer programs that are tangibly included in non-transitory computer-readable storage media, such as the storage unit 18. In accordance with one or more embodiments, part or all of the computer programs can be loaded and/or installed onto the electronic device 10 via the ROM 12 and/or the communication unit 19. When the computer program is loaded into the RAM 13 and executed by the processor 11, one or more steps of the AI-based method for identifying error cause described above can be performed. Alternatively, in other embodiments, the processor 11 can be configured to execute the AI-based method for identifying error cause through any other appropriate means (for example, through firmware).

Various implementations of the systems and techniques described in the present disclosure may be achieved in digital electronic circuit systems, integrated circuit systems, field programmable gate arrays (FPGA), application specific integrated circuits (ASIC), application specific standard products (ASSP), system on chip (SOC), complex programmable logic devices (CPLD), computer hardware, firmware, software, and/or their combinations. These various implementations can include: implementation in one or more computer programs that can be executed and/or interpreted on a programmable system including at least one programmable processor, which may be special or general purpose programmable processor, can receive data and instructions from storage system, at least one input device, and at least one output device, and transmit data and instructions to the storage system, the at least one input device, and the at least one output device.

Computer programs for implementing the methods may be written in any combination of one or more programming languages. These computer programs may be provided to processors of general-purpose computers, special-purpose computers, or other programmable data processing devices, such that when executed by the processor, the functions/operations specified in the flowcharts and/or block diagrams are implemented. Computer programs may be executed entirely on the machine, partially on the machine, executed partially on the machine as a standalone software package and partially on a remote machine, or executed entirely on the remote machine or server.

In the context of the present disclosure, a non-transitory computer-readable storage medium may be a tangible medium that may contain or store computer programs for use by or in connection with instruction execution systems, devices, or equipment. The non-transitory computer-readable storage medium may include, but is not limited to, electronic, magnetic, optical, electromagnetic, infrared, or semiconductor systems, devices, or equipment, or any suitable combination of the above. Alternatively, the non-transitory computer-readable storage medium may be a machine-readable signal medium. More specific examples of machine-readable storage media may include electrical connections based on one or more wires, portable computer disks, hard disks, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination of the above.

To provide interaction with users, the systems and techniques described here may be implemented on electronic devices that have a display device (such as CRT (cathode ray tube) or LCD (liquid crystal display) monitors) for displaying information to users; and a keyboard and pointing device (such as a mouse or trackball) through which users can provide input to the electronic device. Other types of devices may be used to provide interaction with users; for example, feedback provided to users may be any form of sensory feedback (for example, visual feedback, auditory feedback, or tactile feedback); and input from users may be received in any form, including acoustic input, speech input, or tactile input.

The systems and techniques described here may be implemented in computing systems that include backend components (for example, as data servers), or computing systems that include middleware components (for example, application servers), or computing systems that include frontend components (for example, user computers with graphic user interfaces or web browsers through which users can interact with implementations of the systems and techniques described here), or computing systems including any combination of such backend components, middleware components, or frontend components. The components of the system may be interconnected by any form or medium of digital data communication (for example, communication networks). Examples of communication networks include: local area networks (LAN), wide area networks (WAN), blockchain networks and the Internet.

The computing system may include a client and a server. The client and the server are generally remote from each other and typically interact over a communication network. The client-server relationship is created by a computer program that runs on a corresponding computer and has a client-server relationship with each other. The server may be a cloud server, also known as a cloud computing server or cloud host, which is a host product in the cloud computing service system to address the defects of management difficulties and weak business scalability which exist in the traditional physical host and VPS services.

It should be understood that steps may be reordered, added, or deleted using various forms of processes shown above. For example, the steps disclosed in the present disclosure may be performed in parallel or sequentially or in a different order, as long as the desired results of the technical solutions of the present disclosure can be achieved, and no limitation is made herein.

The above-mentioned specific embodiments do not constitute a limitation on the scope of protection of the present disclosure. It should be appreciated by those skilled in the art that various modifications, combinations, sub-combinations and substitutions may be made according to design requirements and other factors. Any modifications, equivalent substitutions and improvements, etc. made within the principles of the present disclosure shall be included in the scope of protection of the present disclosure.

What is claimed is:

1. An artificial intelligence-based (AI-based) method for identifying error cause, the method comprising:
responding to a user's upload operation of at least one draft paper file for at least one target question, wherein the draft paper file comprises one or more problem-solving ideas or problem-solving steps generated by the user for the target question;
acquiring at least one current user error cause generated by an error cause analysis model based on the at least one of the problem-solving idea or the problem-solving step; and
determining an error cause analysis result of the draft paper file according to the current user error cause, and displaying the error cause analysis result on an answer page of the target question.

2. The method of claim 1, wherein the determining an error cause analysis result of the draft paper file according to the current user error cause comprises:
locating an error cause pool corresponding to the target question, wherein the error cause pool is a directed graph with target questions, error cause types, candidate user error causes, candidate error cause analysis, and candidate error cause knowledge points as various hierarchical nodes, and subordinate relationships between hierarchical nodes as directed edges; the error cause pool comprises a plurality of candidate user error causes under the same target question and the candidate error cause analysis corresponding to the plurality of candidate user error causes;
in response to determining that the current user error cause of the target question exists in the error cause pool, determining an error cause type of the current user error cause; wherein the error cause type comprises knowledge point error cause and non-knowledge point error cause;
in response to a first determination that the error cause type of the current user error cause is the knowledge point error cause, identifying at least one candidate error cause knowledge point corresponding to the current user error cause in the error cause pool, and taking an identified candidate error cause knowledge point as the error cause analysis result of the draft paper file; and
in response to a second determination that the error cause type of the current user error cause is the non-knowledge point error cause, identifying the candidate error cause analysis corresponding to the current user error cause in the error cause pool, and taking an identified candidate error cause analysis as the error cause analysis result of the draft paper file.

3. The method of claim 2, wherein the determining an error cause analysis result of the draft paper file according to the current user error cause further comprises:
in response to determining that the current user error cause of the target question does not exist in the error cause pool, acquiring an error cause type of the current user error cause generated by the error cause analysis model;
in response to the second determination that the error cause type of the current user error cause is the non-knowledge point error cause, acquiring the error cause analysis result of the draft paper file generated by the error cause analysis model based on the current user error cause;
in response to the first determination that the error cause type of the current user error cause is the knowledge point error cause, acquiring a first error cause knowledge point that has knowledge correlation with the current user error cause generated by the error cause analysis model, wherein the knowledge correlation is determined based on a subordinate relationship between the current user error cause, the target question and a question knowledge point; and
taking a candidate error cause knowledge point matching with the first error cause knowledge point in an error cause knowledge point graph as the error cause analysis result of the draft paper file.

4. The method of claim 3, wherein the taking a candidate error cause knowledge point matching with the first error cause knowledge point in an error cause knowledge point graph as the error cause analysis result of the draft paper file comprises:
acquiring a candidate error cause knowledge point matching with the first error cause knowledge point from the error cause knowledge point graph as a second error cause knowledge point;
acquiring historical answer data of the target question, wherein the historical answer data comprises a first knowledge point set learned by learners who correctly answered the target question, and a second knowledge point set learned by learners who incorrectly answered the target question;
taking at least one candidate error cause knowledge point that exists in the first knowledge point set but not in the second knowledge point set as a third error cause knowledge point; and
taking the second error cause knowledge point and the third error cause knowledge point as the error cause analysis result of the draft paper file.

5. The method of claim 2, wherein the non-knowledge point error cause comprises at least one of unclear review of question, carelessness, and transcription error.

6. The method of claim 1, wherein the responding to a user's upload operation of at least one draft paper file for at least one target question comprises:
responding to the user's answer operation for the target question, to take an electronic draft paper as the draft paper file when the electronic draft paper is detected; and
responding to the user's upload operation of the electronic draft paper.

7. The method of claim 4, after the determining an error cause analysis result of the draft paper file according to the current user error cause, and displaying the error cause analysis result on an answer page of the target question, further comprising:
displaying the second error cause knowledge point and the third error cause knowledge point on a bottom area of an answer area, wherein the answer page comprises the answer area; and
in response to a user's click operation on any error cause knowledge point among the second error cause knowledge point or the third error cause knowledge point in the bottom area, displaying knowledge analysis content corresponding to a clicked error cause knowledge point on the answer page, wherein the knowledge analysis content comprises one or more of video content or graphic content.

8. The method of claim 3, after the determining an error cause analysis result of the draft paper file according to the current user error cause, further comprising:
updating the current user error cause, the error cause analysis result, and the first error cause knowledge point generated by the error cause analysis model into the error cause pool.

9. The method of claim 1, before the responding to a user's upload operation of at least one draft paper file for at least one target question, further comprising:
acquiring one or more of a standard answer of the target question or a user's answer content for the target question, and updating the draft paper file by taking the one or more of the standard answer of the target question or the user's answer content for the target question as part of the draft paper file.

10. The method of claim 1, before the acquiring at least one current user error cause generated by an error cause analysis model based on the at least one of the problem-solving idea or the problem-solving step, further comprising:
acquiring historical problem-solving information, wherein the historical problem-solving information comprises a historical user error cause, a historical error cause type, and a historical error cause analysis result corresponding to one or more users' answer content for one or more target questions in one or more subjects; and
inputting the historical user error cause, the historical error cause type, and the historical error cause analysis result into a large language model, training the large language model in a supervised manner until an output result of the large language model meets a preset result for the historical user error cause, the historical error cause type, and the historical error cause analysis result, and taking the trained large language model as the error cause analysis model.

11. The method of claim 4, further comprising:
determining associated questions respectively related to the at least one candidate error cause knowledge point, the first error cause knowledge point, the second error cause knowledge point and the third error cause knowledge point corresponding to the current user error cause; and
pushing the associated questions.

12. An artificial intelligence-based (AI-based) apparatus for identifying error cause, the apparatus comprising:
an operation response assembly, configured to respond to a user's upload operation of at least one draft paper file for at least one target question, wherein the draft paper file comprises one or more problem-solving ideas or problem-solving steps generated by the user for the target question;
an error cause acquisition assembly, configured to acquire at least one current user error cause generated by a trained error cause analysis model based on the at least one of the problem-solving idea or the problem-solving step; and
a result generation assembly, configured to determine an error cause analysis result of the draft paper file according to the current user error cause, and display the error cause analysis result on an answer page of the target question.

13. The apparatus of claim 12, wherein the result generation assembly comprises:
an error cause pool locator, configured to locate an error cause pool corresponding to the target question, wherein the error cause pool is a directed graph with target questions, error cause types, candidate user error causes, candidate error cause analysis, and candidate error cause knowledge points as various hierarchical nodes, and subordinate relationships between hierarchical nodes as directed edges; the error cause pool comprises a plurality of candidate user error causes under the same target question and the candidate error cause analysis corresponding to the plurality of candidate user error causes;
an error cause type determiner, configured to, when the current user error cause of the target question exists in the error cause pool, determine an error cause type of the current user error cause; wherein the error cause type comprises knowledge point error cause and non-knowledge point error cause;
a first result determiner, configured to, when the error cause type of the current user error cause is the knowledge point error cause, identify at least one candidate error cause knowledge point corresponding to the current user error cause in the error cause pool, and take an identified candidate error cause knowledge point as the error cause analysis result of the draft paper file; and
a second result determiner, configured to, when the error cause type of the current user error cause is the non-knowledge point error cause, identify the candidate error cause analysis corresponding to the current user error cause in the error cause pool, and take an identified candidate error cause analysis as the error cause analysis result of the draft paper file.

14. The apparatus of claim 12, wherein the result generation assembly further comprises:
an error cause type acquirer, configured to, when the current user error cause of the target question does not exist in the error cause pool, acquire an error cause type of the current user error cause generated by the error cause analysis model;
a third result determiner, configured to, when the error cause type of the current user error cause is the non-knowledge point error cause, acquire the error cause analysis result of the draft paper file generated by the error cause analysis model based on the current user error cause;
a knowledge point determiner, configured to, when the error cause type of the current user error cause is the knowledge point error cause, acquire a first error cause knowledge point that has knowledge correlation with the current user error cause generated by the error cause analysis model, wherein the knowledge correlation is determined based on a subordinate relationship between the current user error cause, the target question and a question knowledge point; and
a fourth result determiner, configured to take a candidate error cause knowledge point matching with the first error cause knowledge point in an error cause knowledge point graph as the error cause analysis result of the draft paper file.

15. The apparatus of claim 14, wherein the knowledge point determiner is further configured to:
acquire a candidate error cause knowledge point matching with the first error cause knowledge point from the error cause knowledge point graph as a second error cause knowledge point;
acquire historical answer data of the target question, wherein the historical answer data comprises a first knowledge point set learned by learners who correctly answered the target question, and a second knowledge point set learned by learners who incorrectly answered the target question;
take at least one candidate error cause knowledge point that exists in the first knowledge point set but not in the second knowledge point set as a third error cause knowledge point; and
take the second error cause knowledge point and the third error cause knowledge point as the error cause analysis result of the draft paper file.

16. The apparatus of claim 13, wherein the non-knowledge point error cause comprises at least one of unclear review of question, carelessness, and transcription error.

17. The apparatus of claim 12, wherein the operation response assembly is further configured to:
respond to the user's answer operation for the target question, to take an electronic draft paper as the draft paper file when the electronic draft paper is detected; and
respond to the user's upload operation of the electronic draft paper.

18. An electronic device, comprising:
at least one processor; and
a memory communicatively connected with the at least one processor; wherein
the memory stores a computer program executable by the at least one processor, and the computer program are executed by the at least one processor to enable the at least one processor to perform acts comprising:
responding to a user's upload operation of at least one draft paper file for at least one target question, wherein the draft paper file comprises one or more problem-solving ideas or problem-solving steps generated by the user for the target question;
acquiring at least one current user error cause generated by an error cause analysis model based on the at least one of the problem-solving idea or the problem-solving step; and
determining an error cause analysis result of the draft paper file according to the current user error cause, and displaying the error cause analysis result on an answer page of the target question.

19. The electronic device of claim 18, wherein the responding to a user's upload operation of at least one draft paper file for at least one target question comprises:
responding to the user's answer operation for the target question, to take an electronic draft paper as the draft paper file when the electronic draft paper is detected; and
responding to the user's upload operation of the electronic draft paper.

20. The electronic device of claim 18, before the responding to a user's upload operation of at least one draft paper file for at least one target question, the acts further comprising:
acquiring one or more of a standard answer of the target question or a user's answer content for the target question, and updating the draft paper file by taking the one or more of the standard answer of the target question or the user's answer content for the target question as part of the draft paper file.
